(19) United States
(12) Patent Application Publication
(10) Pub. No.: US 2016/0005520 A1
(43) Pub. Date: Jan. 7, 2016

(54) INDUCTOR AND METHOD OF MANUFACTURING THE SAME

(71) Applicant: Chang Mao CHENG, Dongguan City (CN)

(72) Inventor: Chang Mao CHENG, Dongguan City (CN)

(21) Appl. No.: 14/677,172

(22) Filed: Apr. 2, 2015

(30) Foreign Application Priority Data
Jul. 4, 2014 (CN) 201410318564.X

(51) Int. Cl. H01F 27/04; H01F 27/29; H01F 27/255

(52) U.S. Cl. CPC H01F 27/04; H01F 27/255; H01F 27/29

(57) ABSTRACT

An inductor and a method of manufacturing the same are disclosed. The inductor comprises: a magnetic core; at least a set of conducting coils, sleeved on the magnetic core, each of the conducting coils including a toroidal coil portion and two extending portions extending from two ends of the toroidal coil portion towards a same direction; the magnetic cover body, hermetically covering and fixing to peripherals of the conducting coil and the magnetic core; and an upper lid and the lower lid; wherein the magnetic core, the conducting coil, the magnetic cover body, the upper lid and the lower lid are integrally formed. Each of the magnetic core, the magnetic cover body, the upper lid and the lower lid includes components of an iron powder, a phosphoric acid, and a resin. When a coil turn number of the conducting coil exceeds a predetermined value, the toroidal coil portion includes at least two layers of parallelly disposed coil windings. The disclosure is adapted to a power supply, an uninterruptable power supply, an air-conditioner frequency converter and power inverter and has a lower cost and better inductance characteristics.

### CROSS REFERENCE TO RELATED APPLICATIONS

This application claims the priority to and the benefit of Chinese Patent Application No. CN201410318564.X, filed on Jul. 4, 2014, and entitled INDUCTOR AND METHOD FOR METHOD FOR MANUFACTURING THE SAME, which is incorporated herein by reference in its entirety.

### TECHNICAL FIELD

The present disclosure generally relates to an inductor, and particularly to an inductor having a high current resistance and a high efficiency, adapted to a power supply, an uninterruptable power supply, an air-conditioner frequency converter, and a power inverter, and a method for manufacturing the same.

### BACKGROUND

Conventional inductors are E-type, cylinder-type, toroidal type, or I-shaped inductors, which have disadvantages hereinbelow:

1. The conducting coil is exposed out of the magnetic core, being vulnerable to external electromagnetic interference, and the magnetic path is relatively long.

2. The conventional conducting coil is formed with a single-layer wound coil. If there are too many turns of the single-layer wound coil, an inductor may be too high, which also increases the length of magnetic path. As a result, according to the formula

$$L ( nH ) = \frac{4 π μ {AN}^{2}}{𝓁} ,$$

an increased number of turns are needed to achieve equal inductance value. In such case, under the same current load, the magnetic field intensity will be increased, thus the inductance value attenuation will be increased.

3. Moreover, because of the increased number of turns, a thicker electric conductor is needed for winding the coil in order to achieve the same DCR (directive current resistance). As a result, to achieve a single-layer coil having the same inductance value and DCR, the conductor (wire) for winding the coil has to be longer and thicker, which substantively increases the cost for the wire, as well as the manufacturing cast and difficulty.

4. In addition, the saturation characteristic of the conventional inductor may be poor due to the limitation of the composition thereof, which also increases the inductance value attenuation.

### SUMMARY

An objective of the disclosure is to overcome the problems in the prior art and provide an inductor and a method for manufacturing the same, for solving the following problems of the conventional inductor: the conducting coil is exposed out of the inductor and is suffered from electromagnetic interference; the conducting coil is wound by a single-layer to cause an over-large inductance value attenuation; the manufacturing cost and difficulty are increased due to an increment of the turn number; and inductance value is poor due to the composition of the inductor.

To solve the problem above, an inductor is provided. The inductor includes: a magnetic core; at least a set of conducting coils, sleeved on the magnetic core, each of the conducting coils including a toroidal coil portion and two extending portions extending from two ends of the toroidal coil portion towards a same direction, the two extending portions extending out of a magnetic cover body and passing through a lower lid to form two electrode terminals capable of being inserted in a circuit board; the magnetic cover body, hermetically covering and fixing to peripherals of the conducting coil and the magnetic core; an upper lid and the lower lid, matching the magnetic cover body in shape and being disposed at a top and a bottom of the magnetic cover body, respectively; the magnetic core, the conducting coil, the magnetic cover body, the upper lid and the lower lid being integrally formed.

Each of the magnetic core, the magnetic cover body, the upper lid and the lower lid includes components of an iron powder, a phosphoric acid, and a resin. A mass percent of the phosphoric acid to the iron powder is 0.04% to 6%, and a mass percent of the resin to the iron powder is 0.5% to 10%. When a coil turn number of the conducting coil exceeds a predetermined value, the toroidal coil portion includes at least two layers of parallelly disposed coil windings.

In some embodiments, the inductor includes at least two sets of conducting coils being wrapped around the magnetic core, by taking the magnetic core as a center shaft and sleeving along a radius direction of a cross section of the magnetic core. The extending portions of each set of the conducting coils extend out of the magnetic cover body and the lower lid to form two electrode terminals.

In some embodiments, a recess is disposed in the lower lid and the extending portions extend out of the recess, the parts of the extending portions which extend out of the recess are the electrode terminals of the inductor.

In some embodiments, the conducting coil of the inductor is provided with a casing tube for improving a insulation ability of the coil.

In some embodiments, the magnetic cover body, the upper lid and the lower lid include an iron powder being one of a reduced iron powder, a carbonyl iron powder, and an alloy.

In some embodiments, the magnetic core includes an iron powder being one of a ferrite, a reduced iron powder, a carbonyl iron powder, and an alloy.

In some embodiments, the alloy may be a Fe—Si powder or a Fe—Si—Al powder.

In some embodiments, the resin includes at least one of a phenolic resin, an epoxy resin, a polyester resin, and a Si resin.

In some embodiments, the magnetic core is a cylindrical magnetic core.

In some embodiments, the predetermined value of the coil turn number of the conducting coil (winding) is five.

A method of manufacturing an inductor is disclosed. The method includes the following steps: according to the electrical characteristics of the inductor to be manufactured, preparing a conducting coil, including: preparing at least a set of conducting coils, each set of which includes a toroidal coil portion and two extending portions extending from two ends of the toroidal coil portion towards a same direction, when a coil turn number of the conducting coil to be wound exceeds a predetermined value, a parallel multi-layer-winding method is performed to make the toroidal coil portion of the conducting coil have at least two layers of coil windings arranged parallel; preparing a powder for forming a magnetic core, an upper lid, a lower lid and a magnetic cover body, and making each of the magnetic core, the upper lid, the lower lid and the magnetic cover body contain components including an iron powder, a phosphoric acid, and a resin; preparing the magnetic core, the upper lid and the lower lid by molding the powder obtained from the above step according to predetermined shapes thereof, respectively; molding the inductor, including: sleeving the conducting coil onto the magnetic core, the extending portions passing through the lower lid and being inserted to a mold, pouring the powder of the magnetic cover body around the conducting coil and the magnetic core, and then covering the upper lid upon the magnetic cover body to perform a pressure molding so as to mold the inductor, wherein the extending portions of the conducting coil extending out of the magnetic cover body are electrode terminals of the inductor; and post processing after molding, including: baking the molded inductor for a predetermined time at a predetermined temperature, then spraying a surface of the inductor with an epoxy resin or a particulate matter to perform coating, at last removing an enamel film or a paint film on the electrode terminals, painting the electrode terminals with a soldering agent and soldering the electrode terminals with tin.

In some embodiments, the step of preparing the powder for forming the magnetic core, the upper lid, the lower lid and the magnetic cover body includes: (a) adding the phosphoric acid and a promoter to an alcohol and uniformly stirring to form a solution, putting the solution into the iron powder and stirring, and then baking and stirring to obtain the powder; (b) adding a resin to an alcohol and uniformly stirring to form a solution, putting the solution into the powder obtained from the above step and stirring, screening the powder after the powder is half-dry, and screening the powder again after baking, so as to obtain a powder; (c) baking the powder obtained from step (b); (d) repeating step (b) to the powder obtained from step (c), and keeping the powder standing to dry at room temperature; and (e) adding a lubricant to the powder obtained from step (d), and, after uniformly mixing and stirring, obtaining a powder for forming the magnetic core, the upper lid, the lower lid and the magnetic cover body.

In some embodiments, before the step of preparing the conducting coil, the method further includes: sleeving a conducting coil (conducting wire) with a casing tube, and then winding the conducting coil.

In some embodiments, the step of preparing the conducting coil further includes: soaking the conducting coil with a lacquer varnish or an epoxy resin after winding the conducting coil.

In some embodiments, before the step of removing the enamel film or paint film on the electrode terminals, painting the electrode terminals with the soldering agent and soldering the electrode terminals with tin, the method further includes: removing the casing tube at the electrode terminals.

In some embodiments, in the components of each of the magnetic core, the magnetic cover body, the upper lid and the lower lid, a mass percent of the phosphoric acid to the iron powder is 0.04% to 6%, and a mass percent of the resin to the iron powder is 0.5% to 10%.

Compared with the conventional technology, the disclosed inductor and method for manufacturing the same disclosure has at least one of advantageous effects below: the magnetic core made of a Fe—Si powder has an improved saturation characteristics of the iron core and a reduced attenuation in inductance value; in addition, the integrally-formed structure and parallel-wound coils can further confine the magnetic circuit of the inductor inside the inductor, which avoids an outside interference, reduces a length of magnetic path of the inductor; furthermore, the more the layer turn number is, the lower the coil height is, and the shorter the magnetic path is, as a result, less turns are used to achieve the same inductance value, and therefore the turn number is reduced; less turns are used to achieve the same inductance value, thus, there is no need to use longer and thicker conducting wire, which reduces manufacturing cost and difficulty, and improves inductance characteristic of the inductor.

### BRIEF DESCRIPTION OF THE DRAWINGS

FIG. 1 is a schematic diagram showing a conducting coil in an embodiment of the disclosure.

FIG. 2 is a schematic diagram showing the conducting coil in FIG. 1 sleeved with a casing tube.

FIG. 3 is a structural schematic diagram showing an inductor using the conducting coil in FIG. 1.

FIG. 4 is a schematic diagram showing the inductor in FIG. 3 assembled on a circuit board.

FIG. 5 is a structural diagram showing an inductor in another embodiment of the disclosure using the conducting coil in FIG. 1.

FIG. 6 is a bottom view of FIG. 5.

FIG. 7 is a structural schematic diagram showing two conducting coils in an embodiment of the disclosure.

FIG. 8 is a schematic diagram showing the conducting coils in FIG. 7 sleeved with a casing tube.

FIG. 9 is a structural schematic diagram showing an inductor using the conducting coil in FIG. 8.

FIG. 10 is a bottom view of FIG. 9.

FIG. 11 is a structural schematic diagram showing the inductor using the conducting coils in FIG. 8.

FIG. 12 is a bottom view of FIG. 11.

FIG. 13 is a structural schematic diagram showing two conducting coils in another embodiment of the disclosure.

FIG. 14 is a schematic diagram showing the conducting coils in FIG. 13 sleeved with a casing tube.

FIG. 15 is a schematic diagram showing the structure of the inductor using the conducting coils in FIG. 14.

FIG. 16 is a bottom view of FIG. 15.

FIG. 17 is a structural schematic diagram showing the inductor using the conducting coils in FIG. 14 in another embodiment of the disclosure.

FIG. 18 is a bottom view of FIG. 17.

FIGS. 19 to 22 are schematic diagrams showing the process of preparing a magnetic core in an embodiment of the disclosure.

FIGS. 23 to 26 are schematic diagrams showing the process of preparing an upper lid in an embodiment of the disclosure.

FIGS. 27 to 29 are schematic diagrams showing the process of preparing a lower lid in an embodiment of the disclosure.

FIGS. 30 to 32 are schematic diagrams showing the process of manufacturing the inductor by pressure molding in an embodiment of the disclosure.

FIG. 33 is a schematic diagram showing the characteristic comparison of the inductor according to the disclosure and two conventional products.

FIG. 34 is a schematic diagram showing the inductance value attenuation comparison of the inductor according to the disclosure and two conventional products.

The reference numerals are listed herebelow:
P1: magnetic core
P2: upper lid
P3: lower lid
P31: recess
T1: conducting coil
T11: toroidal coil portion
T12: extending portion
T13: casing tube
P4: magnetic cover body
G1: hard mold
G2: hard mold
G3: hard mold
W1: movable mold
T1: movable mold
W2: movable mold
T2: movable mold
W3: movable mold
T3: movable mold

### DETAILED DESCRIPTION

Hereinafter, concept and structure of the embodiments of the present disclosure will be described in detail in conjunction with the drawings.

Embodiments of Inductor

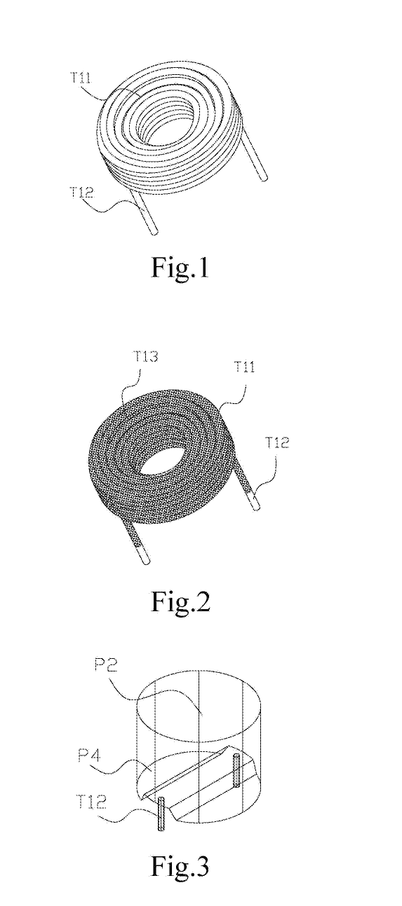

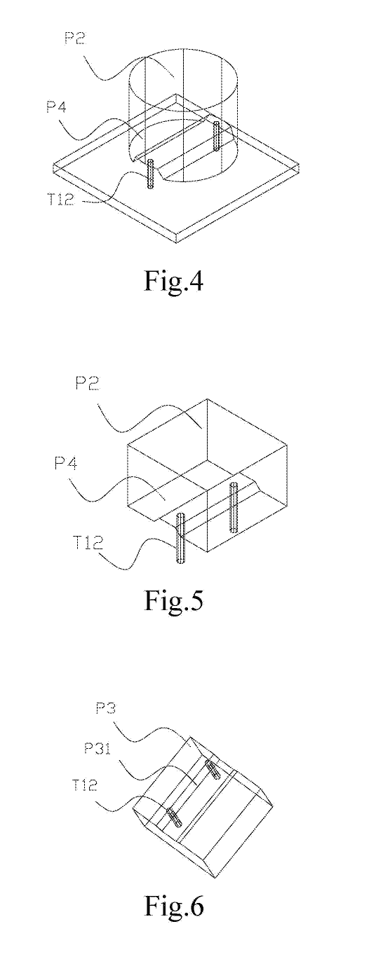

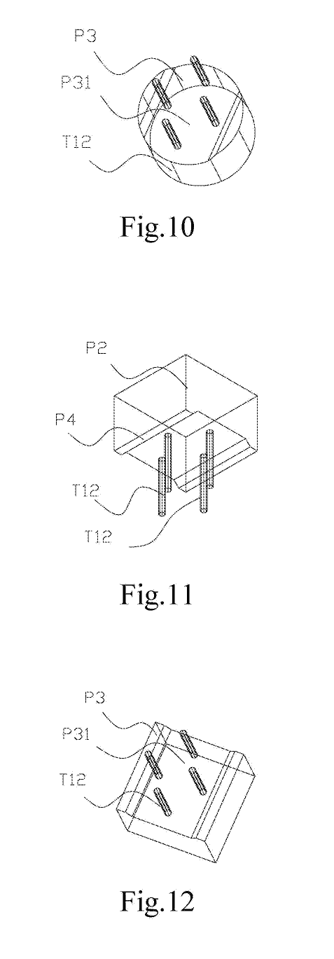

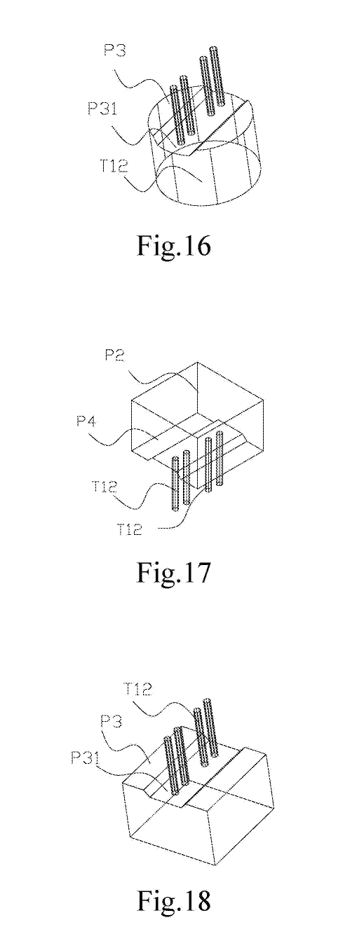

As shown from FIG. 1 to FIG. 18, an inductor in an embodiment of the disclosure includes a magnetic core P1, at least a set of conducting coils T1 sleeved on the magnetic core P1, a magnetic cover body P4, a lower lid P3, and an upper lid P2. The conducting coil T1 includes a toroidal coil portion T11, and two extending portions T12 extending in a same direction from two ends of the toroidal coil portion T11. The two extending portions T12 of the conducting coil T1 extend out of the magnetic cover body P4, and pass through the lower lid P3 to form two electrode terminals which may be inserted in a circuit board. The magnetic cover body P4 hermetically covers and fixes to peripherals of the conducting coil T1 and the magnetic core P1. The upper lid P2 and the lower lid P3 match the magnetic cover body P4 in shape and are disposed at a top and a bottom of the magnetic cover body P4. The magnetic core P1, the conducting coil T1, the magnetic cover body P4, the upper lid P2, and the lower lid P3 are integrally formed. Each of the magnetic core P1, the magnetic cover body P4, the upper lid P2, and the lower lid P3 includes an iron powder, a phosphoric acid, and a resin, with a mass percent of the phosphoric acid to the iron powder in a range from 0.04% to 6%, and a mass percent of the resin to the iron powder in a range from 0.5% to 10%. If the turn number of the conducting coil T1 exceeds a predetermined value, the toroidal coil portion T11 may include at least two layers of parallelly disposed windings.

In an embodiment, the magnetic core P1 may be a cylinder magnetic core.

As shown in FIGS. 1 and 2, if the number of turns for winding the conducting coil T1 exceeds the predetermined value, a parallel multi-layer-winding method may be adopted, such that the toroidal coil portion T11 of the conducting coil T1 includes at least two layers of windings parallel arranged. The turn number is determined by height and/or inductance and so on of the inductor. The turn number in each layer may not exceed a predetermined value. In an embodiment, if the predetermined value is five, the first layer of the conducting coil T1 has five turns. In an embodiment, the conducting coil T1 may have five layers of coils (windings). Moreover, the conducting coil T1 is provided with a casing tube T13 for improving the pressure resistance ability of the coil. The casing tube T13 may be a Teflon casing tube.

As shown from FIG. 3 to FIG. 18, the inductor includes at least two sets of the conducting coils T1. These conducting coils T1 are wrapped around the magnetic core P1, by taking the magnetic core P1 as a center shaft and sleeving along a radius direction of a cross section of the magnetic core P1. The extending portions T12 of each set of the conducting coils T1 extend out of the magnetic cover body P4 and the lower lid P3 to form two electrode terminals.

A recess P31 is disposed in the lower lid P3, and the extending portions T12 extend out of the recess P31. The parts of the extending portions T12 which extend out of the recess P31 serve as the electrode terminals of the inductor.

As shown from FIG. 3 to FIG. 18, the extending portions T12 of the conducting coils T1 may be disposed parallelly/horizontally or vertically, which may be varified according to the user's requirement and is not limited herein.

As shown from FIG. 3 to FIG. 6, the inductor includes only one set of conducting coil T1, so that the inductor has two extending electrode terminals which may be inserted into the circuit board. The two electrode terminals extend out of the recess P31. The inductor may have a shape of cylinder or rectangle.

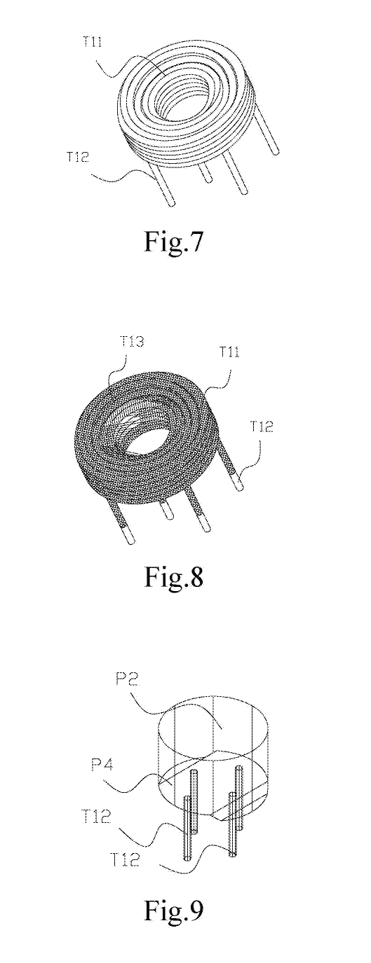

As shown from FIG. 7 to FIG. 12, the inductor includes two sets of conducting coils T1, so that two sets of electrode terminals which may be fixedly inserted in the circuit board extend out of the inductor. The two sets of electrode terminals extend out of the recess P31. Moreover, the two sets of electrode terminals are vertical in the recess P31, that is, the extending pins of the two sets of electrode terminals are vertical. The inductor may have a shape of cylinder or rectangle. In other embodiments, the inductor may have more sets of the conducting coils T1, and the electrode terminals of the conducting coils T1 may not be arranged in parallel.

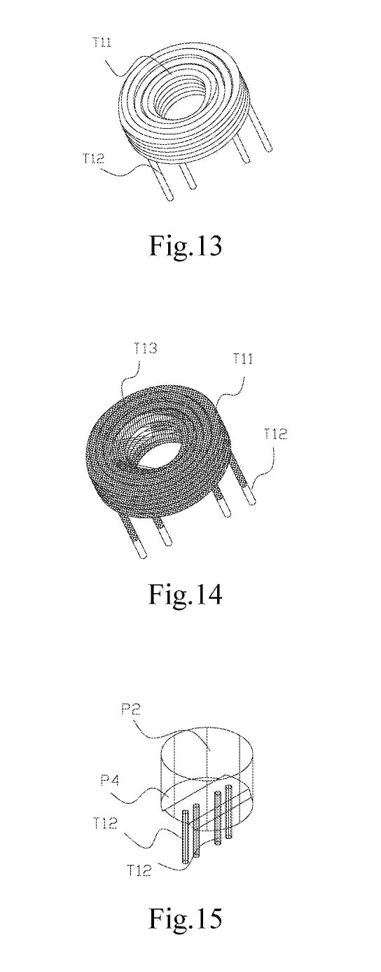

As shown from FIG. 13 to FIG. 18, the inductor includes two sets of the conducting coils T1, so that two sets of extending electrode terminals which may be fixedly inserted in the circuit board extend out of the inductor. The two sets of electrode terminals extend out of the recess P31 and are positioned in a same straight line in the recess P31, that is, the extending pins of the two sets of electrode terminals are parallel. The inductor may have a shape of cylinder or rectangle. In other embodiments, the inductor may have more sets of the conducting coils T1, and the electrode terminals of the conducting coils T1 may be parallel.

The magnetic core P1, the upper lid P2, the lower lid P3 and the magnetic cover body P4 each includes components of iron powder, phosphoric acid, and resin. In an embodiment, the magnetic core P1 includes an iron powder being one of a ferrite, a reduced iron powder, a carbonyl iron powder, and an alloy. The magnetic cover body P4, the upper lid P2 and the lower lid P3 include an iron powder being one of a reduced iron powder, a carbonyl iron powder, and an alloy. The alloy may be a Fe—Si powder or a Fe—Si—Al powder. The resin includes at least one of a phenolic resin, an epoxy resin, a polyester resin, and a Si resin. The phosphoric acid includes a zinc stearate.

Embodiments of Manufacturing an Inductor

A method of manufacturing an inductor according to the disclosure is illustrated hereinbelow:

First, a conducting coil T1 is prepared, which includes the steps of: preparing at least one set of conducting coil T1 according to the electrical characteristics of the inductor to be manufactured, and each set of conducting coil includes a toroidal coil portion T11 and two extending portions T12. The extending portions T12 extending in a same direction from two ends of the toroidal coil portion T11. If the number of coil turns to be wound exceeds a predetermined value, a parallel multi-layer-winding method is adopted, such that the toroidal coil portion T11 of the conducting coil T1 have at least two layers of coil windings which are arranged parallel.

Afterwards, a powder is prepared for forming a magnetic core P1, an upper lid P2, a lower lid P3 and a magnetic cover body P4, such that the magnetic core P1, the upper lid P2, the lower lid P3, and the magnetic cover body P4 contain components including an iron powder, a phosphoric acid, and a resin.

Then, the magnetic core P1, the upper lid P2 and the lower lid P3 are prepared. In this step, the magnetic core P1, the upper lid P2 and the lower lid P3 are formed by molding the powder obtained from the above step according to predetermined shapes.

Next, the inductor is molded. This step includes: sleeving the conducting coil T1 onto the magnetic core P1, with the extending portions T12 passing through the lower lid P3 and being inserted to a mold; then pouring the powder for the magnetic cover body P4 around the conducting coil T1 and the magnetic core P1; and then covering the upper lid P2 upon the magnetic cover body P4 to perform pressure molding, so as to mold the inductor. In this step, the extending portions T12 of the conducting coil T1, which extend out of the magnetic cover body P4, are electrode terminals of the inductor.

At last, a post processing after molding is performed. The post processing includes: baking the molded inductor for a predetermined time at a predetermined temperature; then, spraying a surface of the inductor with an epoxy resin or coating the surface of the inductor with an epoxy powder; at last, removing an enamel film or paint film on the electrode terminals, painting the electrode terminals with a soldering agent and soldering the electrode terminals with tin.

To make a skilled person in the art fully understand the concept of the disclosure, hereinafter, implementations of methods of manufacturing an inductor according to the embodiments of the present disclosure will be described in detail in conjunction with the drawings.

I Manufacturing of a Conducting Coil T1

FIGS. 1, 2, 7, 8, 13 and 14 are schematic diagrams showing the structure of the conducting coil T1 according to the disclosure. The conducting coil T1 includes a toroidal coil portion T11 and two extending portions T12. The extending portions T12 extends towards in a same direction from two ends of the toroidal coil portion T11. If the number of turns of the conducting coil T1 to be wound exceeds a predetermined value, a parallel multi-layer-winding method may be adopted, such that the toroidal coil portion T11 of the conducting coil T1 has at least two layers of coil windings which are disposed in parallel. The predetermined value of turns is determined by the characteristic of the inductor itself. For example, a height of the inductor may restrict the turn number, or an inductance value of the inductor may also restrict the turn number in each layer of the coil winding.

Preparing the conducting coil T1 will not be specifically illustrated herein. However, to keep the enamel film complete after final molding, a conducting wire (such as copper wire) for winding the conducting coil T1 may be sleeved with a casing tube such as a Teflon casing tube before winding. In addition, after the conducting coil T1 is formed, it is also possible to soak the conducting coil T1 with a lacquer varnish or an epoxy resin.

II Preparing a Powder for Forming the Magnetic Cover Body P4, the Upper Lid P2, the Lower Lid P3 and the Magnetic Core P1

The process of preparation of the powder for forming the magnetic cover body P4, the upper lid P2, the lower lid P3 and magnetic core P1 includes the steps of:

(a) adding a phosphoric acid and a promoter to an alcohol and uniformly stirring to form a solution, putting the solution into an iron powder and stirring, and then baking and stirring the powder;

(b) adding a resin to an alcohol and uniformly stirring to form a solution, putting the solution into the powder obtained from the above step and stirring, screening the powder after the powder is half-dry, and screening the powder again after baking it, so as to obtain a powder;

(c) baking the powder obtained from the step (b);

(d) repeating the step (b) to the powder obtained from the step (c), and keeping the powder standing to dry at room temperature;

(e) adding a lubricant to the powder obtained from the step (d), and, after uniformly mixing and stirring, obtaining a powder for forming the magnetic core P1, the upper lid P2, the lower lid P3 and the magnetic cover body P4.

In an embodiment, the method of preparing the powder for the magnetic core P1 will be specifically illustrated hereinbelow:

(a) adding a phosphoric acid of 0.4 g-60 g and a promoter of 1 g to an alcohol of 40 g and uniformly stirring to form a solution, adding the solution to a Fe—Si powder of 1 Kg (Fe>99%) and stirring the Fe—Si powder for 15-60 minutes, and, after baking and stirring the Fe—Si powder at 130° C. for 60-180 minutes, obtaining a powder. In an embodiment, the promoter is a phosphatizing promoter, acting as a promoter in a phosphating solution for performing metal phosphating and may promote a quick formation of a phosphating film, and also make the phosphating film uniform and dense. In other embodiments, the Fe—Si powder may be replaced by ferrite, a reduced iron powder, a carbonyl iron powder, or a Fe—Si—Al powder;

(b) adding a phenolic resin of 5 g-100 g to an alcohol of 60 g and uniformly stirring to form a solution, adding the solution to the powder prepared in the above step and stirring the powder for ten minutes, screening the powder with a 24-mesh screen when it is half-dry, baking the powder at 90° C. for 30 minutes, and obtaining a powder after screening the powder again with a 40-mesh screen;

(c) baking the powder obtained from the step (b) at 180° C.-220° C. for 60-180 minutes;

(d) repeating the step (b) to the powder obtained from the step (c), and keeping the powder standing to dry at room temperature for 24 hours; and

(e) adding a zinc stearate of 2 g-8 g as a lubricant to the powder obtained from the step (d), and, after mixing and stirring the powder to uniform, obtaining a powder of the magnetic core P1.

In an embodiment, the method of preparing the magnetic cover body P4, the upper lid P2 and the lower lid P3 includes the steps hereinbelow:

(a) adding a phosphoric acid of 0.4 g-60 g and a promoter of 1 g to an alcohol of 40 g and uniformly stirring to form a solution, adding the solution to a reduced iron powder (Fe>99%) of 1 Kg, stirring the powder for 15-60 minutes, then baking and stirring the powder at 130° C. for 60-180 minutes to obtain a powder. In an embodiment, the promoter is a phosphatizing promoter, acting as a promoter in a phosphating solution for performing metal phosphating, and may promote a quick formation of a phosphating film, and also make the phosphating film uniform and dense. In other embodiments, the Fe—Si powder may be replaced by a ferrite, a reduced iron powder, a carbonyl iron powder, or a Fe—Si—Al powder;

(b) adding a phenolic resin of 5 g-100 g to an alcohol of 60 g and uniformly stirring to form a solution, adding the solution to the powder prepared in the above step and stirring for ten minutes, screening the powder with a 24-mesh screen after it is half-dry, baking the powder at 90° C. for 30 minutes, and screening the powder with a 40-mesh screen again to obtain a powder;

(c) baking the powder obtained from the step (b) at 180-220° C. for 60 to 180 minutes;

(d) repeating the step (b) to the powder obtained from the step (c), and keeping the powder standing to dry under room temperature for 24 hours; and

(e) adding a zinc stearate of 2 g-8 g as a lubricant to the powder obtained from the step (d), and, after uniformly mixing and stirring, obtaining a powder of the upper lid P2, the lower lid P3 and the magnetic cover body P4.

It would be noted, the quality and amount of components, stirring time, baking temperature and time, and standing and drying time in the above preparing method are not limited to those illustrated above, and can be adjusted according to electrical characteristics of the manufactured magnetic cover body P4, the upper lid P2, the lower lid P3 and the magnetic core P1.

All the components of magnetic core P1, the upper lid P2, the lower lid P3 and the magnetic cover body P4 include an iron powder, a phosphoric acid and a resin. In an embodiment, the iron powder of the magnetic core P1 is one of a ferrite, a reduced iron powder, a carbonyl iron powder, and an alloy. The iron powder of the magnetic cover body P4, the upper lid P2 and the lower lid P3 may be one of a reduced iron powder, a carbonyl iron powder, and an alloy. The alloy may be a Fe—Si powder or a Fe—Si—Al powder. The resin includes at least one of a phenolic resin, an epoxy resin, a polyester resin, and a Si resin. The phosphoric acid includes a zinc stearate.

III Preparation of the Magnetic Core P1

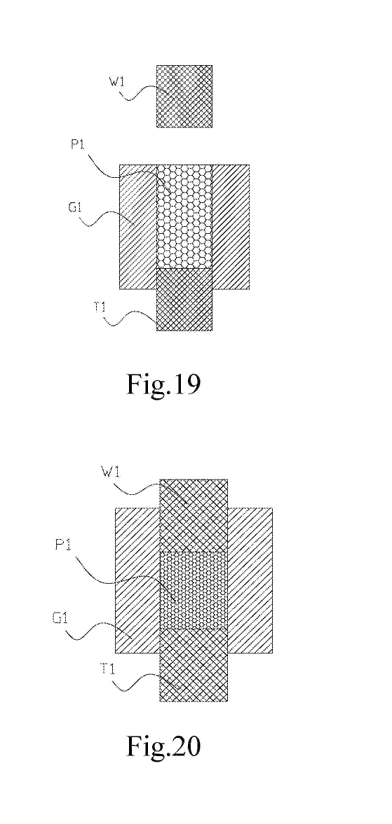

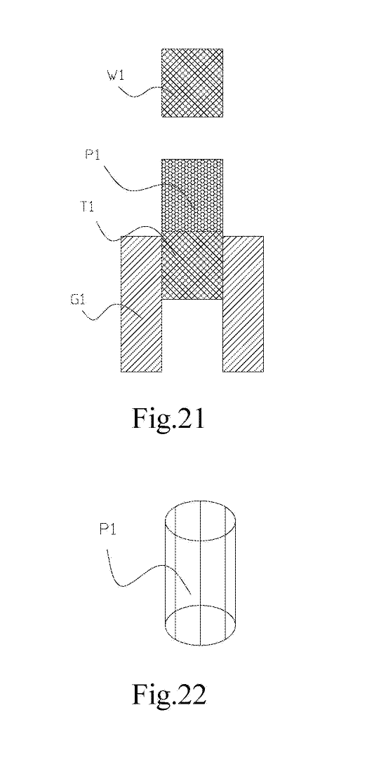

As shown from FIG. 19 to FIG. 22, the powder of the magnetic core P1 is stuffed into a hard mold G1, and a force is applied on a movable mold W1 located above the hard mold G1 to move the movable mold W1 downwardly into the hard mold G1, thus, a force is applied on the powder of the magnetic core P1. Afterwards, when a force is applied on the movable mold T1 below the hard mold G1, the magnetic core P1 may be pushed away from the hard mold G1. In an embodiment, the magnetic core P1 has a shape of a cylinder and a density of 5.0 to 6.0 g/cm³.

IV Preparation of the Upper Lid P2

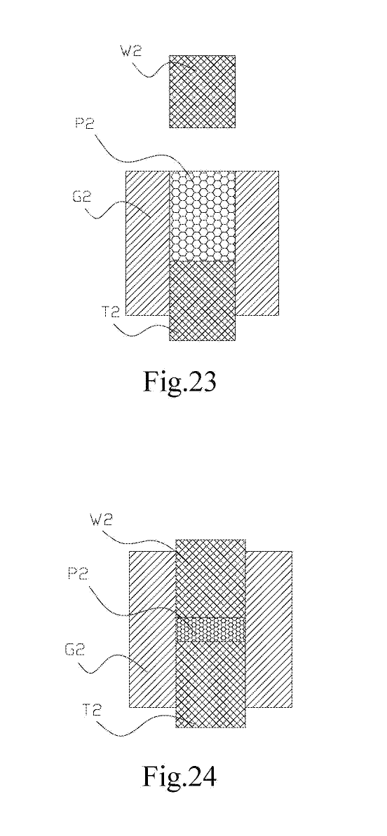

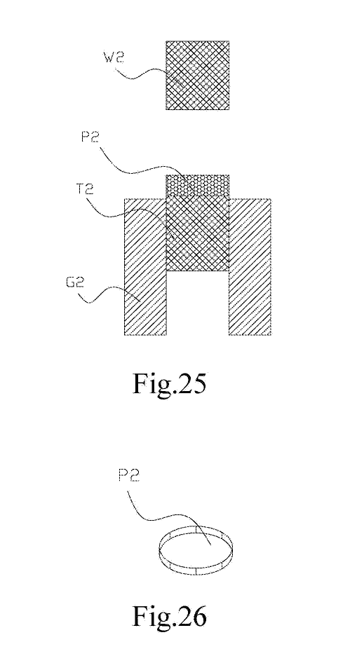

As shown from FIG. 23 to FIG. 26, the powder of the upper lid P2 is stuffed into a hard mold G2, and a force is applied on a movable mold W2 located above the hard mold G2 to move the movable mold W2 downwardly into the hard mold G2, thus, a force is further applied on the powder of the upper lid P2. Afterwards, when a force is applied on the movable mold T2 below the hard mold G2, the upper lid P2 may be pushed away from the hard mold G2. In an embodiment, the upper lid P2 has a shape of a cylinder and a density of 4.0 to 5.0 g/cm³.

V Preparation of the Lower Lid P3

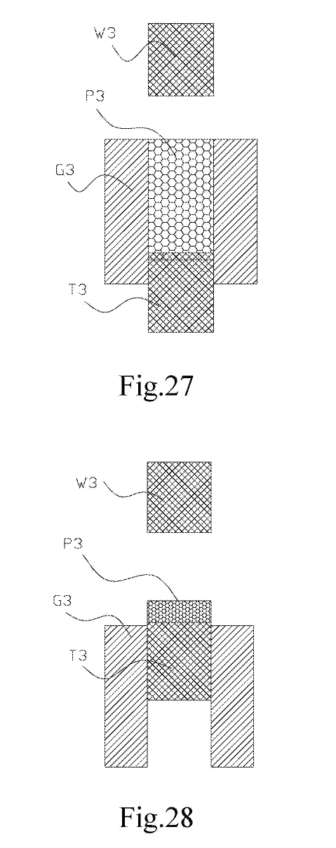

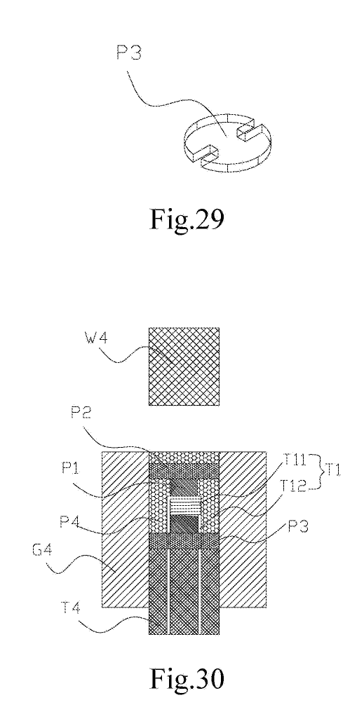

As shown from FIG. 27 to FIG. 29, the powder of the lower lid P3 is stuffed into a hard mold G3, and a force is applied on a movable mold W3 located above the hard mold G3 to move the movable mold W3 downwardly into the hard mold G3, thus, a force is applied on the powder of the lower lid P3. Afterwards, when a force is applied on the movable mold T3 below the hard mold G3, the lower lid P3 may be pushed away from the hard mold G3. In an embodiment, the lower lid P3 has a shape of a cylinder with through holes respectively disposed on two opposite sides for facilitating the extending portions T12 of the conducting coil T1 to extrude therein when the inductor is manufactured. The lower lid P3 has a density of 4.0 to 5.0 g/cm³.

VI Preparation of the Inductor

As shown from FIG. 30 to FIG. 32, firstly, the toroidal coil portion T11 of the conducting coil T1 is sleeved on the magnetic core P1, and the extending portions T12 of the conducting coil T1 pass through the through hole of the lower lid P3 and are inserted onto the movable mold T4. Then, the material for preparing the magnetic cover body P4 is poured around the conducting coil T1 and the magnetic core P1 to make the magnetic cover body P4 wrap and cover the magnetic core P1 and the conducting coil T1. Next, the upper lid P2 is covered above the magnetic cover body P4, and a force is applied to the movable mold W4 above the hard mold G4 to move the movable mold downwardly into the hard mold G4. Then, the magnetic cover body P4, the conducting coil T1, the magnetic core P1, the upper lid P2 and the lower lid P3 may be pressure molded into a complete inductor, and a recess P31 is formed in the bottom of the lower lid P3 by pressure. Then, a force is applied to the movable mold below the hard mold to move the movable mold upwards, such that the inductor may be pushed out of the hard mold. The extending portions T12 of the conducting coil T1 extending out of the magnetic cover body P4 are the electrode terminals of the inductor.

The pressure molded inductor is baked at 150-200° C. for 30-120 minutes, and then its surface is painted by epoxy resin (with or without color), or alternatively, a powder painting is performed. At last, if a Teflon casing tube is arranged around the conducting coil T1, firstly the Teflon casing tube is removed, and then the enamel film or paint film at each of the electrode terminals of the conducting coil is removed, moreover, the electrode terminals is dipped by a scaling powder and soldered with tin. Since the lower lid P3 of the inductor is provided with the recess P31 which may be used to coordinate with the equipment for removing the enamel film or paint film, the equipment can easily remove the enamel film or paint film. Otherwise, without the recess P31, all the enamel film or paint film have to be removed during processing, in such case, the product body is prone to scraping, which may results in a substantively increased defective rate and increase the manufacturing cost.

Analysis about Characteristics of the Inductor

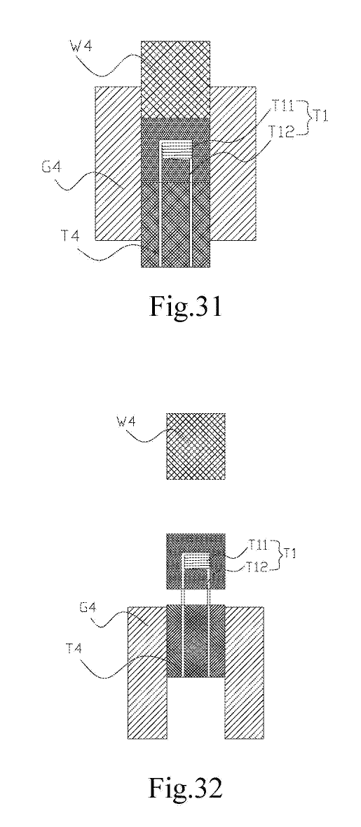

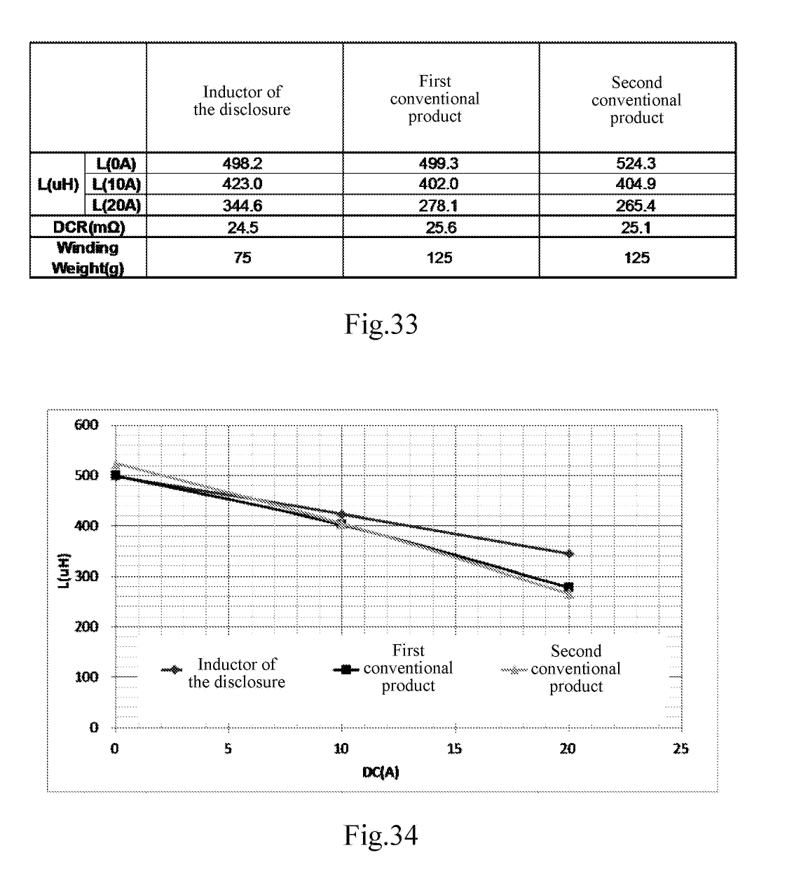

Referring to FIG. 31 and FIG. 32, in a testing environment, a power supply having a voltage of 1V and a frequency of 40 KHZ is provided. As shown in the drawings, when the current is 0, the inductance value of the inductor according to the disclosure is 498.2 μH, the inductance value of the first conventional product is 499.301, and the inductance value of the second conventional product is 524.3 μH. As the current is increased, when the current is about 5 A to 6 A, the inductance value of the inductor according to the disclosure is larger than the two conventional inductors of other companies, moreover, the inductance values of the two inductors of other companies reduce faster than the inductor according to the disclosure, namely, the inductance values of the conventional inductors decrease at speeds faster than the inductor according to the disclosure. When the current is increased to 20 A, the inductance value of the inductor according to the disclosure is still relatively large, while the two conventional inductors have reduced by more than a half. Meanwhile, the inductor according to the disclosure weighs about 75 g, far less than the two conventional inductors each weighing about 125 g. As a result, the inductor according to the disclosure shows no difference compared with the two conventional products in respect to the direct current resistance, however, the inductor according to the disclosure has a lower inductance attenuation under the same current value, and has less weight, too. Less weight means a lower consumption of copper wire and a reduced cost. A lower attenuation of inductance means better inductance characteristics and a low cost. Better characteristics and a low cost would result in a better cost performance.

Hereinafter, the reason why the inductor according to the disclosure saves conducting coil is discussed.

Based on the formula of calculating inductance value of an inductor,

$$L ( nH ) = \frac{4 π μ {AN}^{2}}{𝓁} ,$$

where N represents the turn number, and l represents a magnetic flux path, if the magnetic flux path is reduced, the turn number will be reduced, too. Since the inductor according to the disclosure has a closed and integral structure, all the magnetic lines of force are totally confined in the magnet. Thus, a length of the magnetic flux path can be reduced. Furthermore, a parallel multi-layer winding method is used according to the disclosure, so the more the layers with the same turn number are, the shorter the core length is and the shorter the magnetic circuit is. As a result, a reduced turn number can obtain the same inductance value in the prior art. Thus the conducting coil can be more effective in cost, and the inductance attenuation characteristic can be improved as well.

What should be mentioned is, the inductor according to the disclosure is an integrally-formed product with a large power, which is mainly used in a power supply, an uninterruptable power system, an air conditioning frequency converting and power inverter and so on, in which the inductance value is about 10 μH-3000 μH, and direct resistance is about 5 mOhm-300 mOhm, and the diameter is from 25 mm to 250 mm.

Compared with the conventional technology, the inductor and the method for manufacturing the same according to the disclosure may bring at least one of the following advantageous effects: by means of the magnetic core made of a Fe—Si powder, a saturation characteristic of the iron core can be improved, and the inductance value attenuation can be reduced; besides, the integrally-formed structure and parallel-wound coils may further confine the magnetic circuit of the inductor inside the inductor, which avoids outside interference, reduces a length of the magnetic path of the inductor; furthermore, the more the number of the layers with the same turn number is, the lower the coil height is, and the shorter the magnetic path is, as a result, less turns are used to achieve the same inductance value, therefore, the turn number can be reduced, that is, less turns are used to achieve the same inductance value, thus, there is no need to use the longer and thicker conducting wire, which reduces manufacturing cost and difficulty, and improves inductance characteristic of the inductor.

Apparently, one of ordinary skill in the art can make various changes and modifications to the present disclosure without departing from the spirit and scope of the invention. Thus, the present disclosure intends to encompass such changes and modifications provided that those changes and modifications fall within the scope of claims of the present invention and equivalents thereof.

What is claimed is:

1. An inductor comprising:
a magnetic core;
at least a set of conducting coils, sleeved on the magnetic core, each of the conducting coil including a toroidal coil portion and two extending portions extending from two ends of the toroidal coil portion towards a same direction, the two extending portions extending out of a magnetic cover body and passing through a lower lid to form two electrode terminals capable of being inserted in a circuit board;
the magnetic cover body, hermetically covering and fixing to peripherals of the conducting coil and the magnetic core;
an upper lid and the lower lid, matching the magnetic cover body in shape and being disposed at a top and a bottom of the magnetic cover body, respectively;
the magnetic core, the conducting coil, the magnetic cover body, the upper lid and the lower lid being integrally formed;
wherein each of the magnetic core, the magnetic cover body, the upper lid and the lower lid includes components of an iron powder, a phosphoric acid, and a resin, with a mass percent of the phosphoric acid to the iron powder in a range of 0.04% to 6%, and a mass percent of the resin to the iron powder in a range of 0.5% to 10%; when a coil turn number of the conducting coil exceeds a predetermined value, the toroidal coil portion includes at least two layers of parallelly disposed coil windings.

2. The inductor according to claim 1, wherein the inductor comprises at least two sets of conducting coils being wrapped around the magnetic core, by taking the magnetic core as a center shaft and sleeving along a radius direction of a cross section of the magnetic core, and wherein the extending portions of each set of the conducting coils extend out of the magnetic cover body and the lower lid to form two electrode terminals.

3. The inductor according to claim 1, wherein a recess is disposed in the lower lid and the extending portions extends out of the recess, and parts of the extending portions which extend out of the recess are the electrode terminals of the inductor.

4. The inductor according to claim 2, wherein a recess is disposed in the lower lid and the extending portions extends out of the recess, and parts of the extending portions which extend out of the recess are the electrode terminals of the inductor.

5. The inductor according to claim 1, wherein the conducting coil of the inductor is provided with a casing tube for improving a pressure resistance ability of the coil.

6. The inductor according to claim 1, wherein the magnetic cover body, the upper lid and the lower lid contains an iron powder being one of a reduced iron powder, a carbonyl iron powder, and an alloy.

7. The inductor according to claim 1, wherein the magnetic core contains an iron powder being one of a ferrite, a reduced iron powder, a carbonyl iron powder, and an alloy.

8. The inductor according to claim 6, wherein the alloy is a Fe—Si powder or a Fe—Si—Al powder.

9. The inductor according to claim 7, wherein the alloy is a Fe—Si powder or a Fe—Si—Al powder.

10. The inductor according to claim 1, wherein the resin includes at least one of a phenolic resin, an epoxy resin, a polyester resin, and a Si resin.

11. The inductor according to claim 1, wherein the magnetic core is a cylindrical magnetic core.

12. The inductor according to claim 1, wherein the predetermined value of the coil turn number of the conducting coil is five.

13. A method of manufacturing an inductor, comprising the following steps:
preparing a conducting coil according to electrical characteristics of an inductor to be manufactured, including: preparing at least a set of conducting coils, each set of which comprises a toroidal coil portion and two extending portions extending from two ends of the toroidal coil portion towards a same direction, wherein when a coil turn number of the conducting coil to be wound exceeds a predetermined value, a parallel multi-layer-winding method is performed to make the toroidal coil portion of the conducting coil have at least two layers of coil windings arranged parallel;
preparing a powder for forming a magnetic core, an upper lid, a lower lid, and a magnetic cover body, and making each of the magnetic core, the upper lid, the lower lid and the magnetic cover body contain components including an iron powder, a phosphoric acid, and a resin;
preparing the magnetic core, the upper lid and the lower lid by molding the powder obtained from the above step according to predetermined shapes thereof, respectively;
molding the inductor, including: sleeving the conducting coil onto the magnetic core, the extending portions passing through the lower lid and then being inserted to a mold, pouring the powder of the magnetic cover body around the conducting coil and the magnetic core, and then covering the upper lid upon the magnetic cover body to perform a pressure molding so as to mold the inductor, wherein the extending portions of the conducting coil extending out of the magnetic cover body are electrode terminals of the inductor; and
post processing after molding, including: baking the molded inductor for a predetermined time at a predetermined temperature, then spraying a surface of the inductor with an epoxy resin or coating a surface of the inductor with an epoxy powder, removing an enamel film or a paint film on the electrode terminals, painting the electrode terminals with a soldering agent and soldering the electrode terminals with tin.

14. The method of manufacturing the inductor according to claim 13, wherein the step of preparing the powder for forming the magnetic core, the upper lid, the lower lid and the magnetic cover body comprises:
(a) adding the phosphoric acid and a promoter to an alcohol and uniformly stirring to form a solution, putting the solution into an iron powder and stirring, and then baking and stirring to obtain a powder;
(b) adding the resin to an alcohol and uniformly stirring to form a solution, putting the solution in the powder obtained from the above step and stirring, screening the powder after the powder is half-dry, and screening the powder again after baking, so as to obtain a powder;
(c) baking the powder obtained from the step (b);
(d) repeating the step (b) to the powder obtained from the step (c), and keeping the powder standing to dry at room temperature; and
(e) adding a lubricant to the powder obtained from the step (d), and, after uniformly mixing and stirring, obtaining a powder for forming the magnetic core, the upper lid, the lower lid and the magnetic cover body.

15. The method of manufacturing the inductor according to claim 13, wherein before the step of preparing the conducting coil, the method further comprises: sleeving a conducting coil with a casing tube, and then winding the conducting coil.

16. The method of manufacturing the inductor according to claim 13, wherein the step of preparing the conducting coil further comprises: soaking the conducting coil with a lacquer varnish or an epoxy resin after winding the conducting coil.

17. The method of manufacturing the inductor according to claim 15, wherein before the step of removing the enamel film or the paint film on the electrode terminals, painting the electrode terminals with the soldering agent and soldering the electrode terminals with tin, the method further comprising: removing the casing tube at the electrode terminals.

18. The method of manufacturing the inductor according to claim 13, wherein each of the magnetic core, the magnetic cover body, the upper lid and the lower lid contains components with a mass percent of the phosphoric acid to the iron powder in a range of 0.04% to 6%, and a mass percent of the resin to the iron powder in a range of 0.5% to 10%.
